(19) United States
(12) Patent Application Publication
(10) Pub. No.: US 2013/0031902 A1
(43) Pub. Date: Feb. 7, 2013

(54) SYSTEMS AND METHODS FOR AN ENGINE WITH A TWO-STAGE TURBOCHARGER

(71) Applicants: Rodrigo Rodriguez Erdmenger, Garching (DE); Douglas C. Hofer, Niskayuna, NY (US); Jassin Fritz, Garching (DE); Alberto Scotti Del Greco, Florence (IT); Georgios Bikas, Garching (DE); Mark Stablein, Lawrence Park, PA (US); Sebastian Walter Freund, Garching (DE); Vittorio Michelassi, Florence (IT)

(72) Inventors: Rodrigo Rodriguez Erdmenger, Garching (DE); Douglas C. Hofer, Niskayuna, NY (US); Jassin Fritz, Garching (DE); Alberto Scotti Del Greco, Florence (IT); Georgios Bikas, Garching (DE); Mark Stablein, Lawrence Park, PA (US); Sebastian Walter Freund, Garching (DE); Vittorio Michelassi, Florence (IT)

(21) Appl. No.: 13/197,108

(22) Filed: Aug. 3, 2011

(51) Int. Cl. F02C 6/12

(52) U.S. Cl. 60/605.1

(57) ABSTRACT

Various methods and systems are provided for an engine. In one example, the system includes a two-stage turbocharger which has first turbocharger with a first turbine and a first compressor and a second turbocharger with a second turbine and a second compressor, where the first turbine and the second turbine are arranged in parallel and the first compressor and the second compressor are arranged in series. The system may include a duct coupling turbine inlets of the first and second turbine, and a valve coupled between the duct and the inlet of the first turbine to throttle flow to first turbine.

### FIELD

The subject matter disclosed herein relates to systems and methods for an internal combustion engine which includes a two-stage turbocharger.

### BACKGROUND

Turbochargers may be used in an engine system to increase a pressure of air supplied to the engine for combustion. In one example, the turbocharger includes a turbine coupled in an exhaust passage of the engine which at least partially drives a compressor to increase the intake air pressure. In some examples, the engine system may include two or more turbochargers to further increase the pressure of the intake air, such as a two-stage turbocharger which includes two turbochargers. In such an example, the turbines may be arranged in series and the compressors may be arranged in series so the intake air passes through both of the compressors and exhaust gas passes through both of the turbines. During part load conditions, however, efficiency of the turbocharger may be reduced

In one approach, a throttled bypass is provided such that exhaust gas may bypass one of the turbines in the exhaust passage during part load engine operation in order to increase turbocharger efficiency. However, the bypass may result in higher back pressure generating losses and decreasing turbocharger efficiency at full load operation. Furthermore, by including a bypass in the system, a packaging space needed for the system may be increased.

### BRIEF DESCRIPTION

In one embodiment, an engine system includes a two-stage turbocharger. The two-stage turbocharger may include a first turbocharger with a first turbine and a first compressor, and a second turbocharger with a second turbine and a second compressor. The first turbine and the second turbine are arranged in parallel and the first compressor and the second compressor are arranged in series. The system may include a duct coupling turbine inlets of the first and second turbine, and a valve coupled between the duct and the first turbine inlet.

By arranging the first turbine and the second turbine in parallel, exhaust gas that flows through the first turbine may not flow through the second turbine. Further, by including a valve upstream of the first turbine inlet, exhaust flow to the first turbine may be reduced. In this way, losses incurred by ducts connecting the first and second turbines, as well as losses incurred by bypass ducts may be reduced. During operation, it may be possible to shut down the first turbine, thereby passing the complete flow through the second turbine by moving the operation point of the system to an area with relatively higher efficiency. Moreover, a volume of packaging space may not be the same as other multi-turbocharger systems.

In another embodiment, a method for an engine having an exhaust gas recirculation system and a two-stage turbocharger, the two-stage turbocharger including a first turbocharger and a second turbocharger, is provided. The method includes, based on an engine load, adjusting exhaust gas flow to a turbine of the first turbocharger, where the turbine of the first turbocharger is arranged in parallel with a turbine of the second turbocharger, and a compressor of the first turbocharger is arranged in series with a compressor of the second turbocharger, and adjusting an amount of exhaust gas recirculation drawn from upstream of both of the first and second turbines.

In this manner, the two-stage turbocharger may be controlled such that the engine operates with one or two turbochargers. In one example, the first turbine may be shut down during conditions when the engine is under part load conditions, thereby improving a pressure ratio on the second turbine. Further, by adjusting the exhaust gas flow to the first turbine, back pressure may be regulated such that the amount of exhaust gas recirculation may be adjusted.

In another embodiment, a system for an engine includes a first turbocharger including both a first turbine with a first turbine inlet positioned in a first exhaust passage through which exhaust gas flows, and a first compressor positioned downstream of a primary air inlet of an intake passage and through which intake air flows, and a second turbocharger including both a second turbine with a second turbine inlet positioned in a second exhaust passage through which exhaust gas flows, and a second compressor positioned downstream of the first compressor in the intake passage. The system further includes a structure defining a communication duct coupling the first exhaust passage to the second exhaust passage upstream of inlets of the first turbine inlet and the second turbine inlet, an exhaust gas recirculation system having an exhaust gas inlet upstream of the inlets of first and second turbine, and a valve positioned between the communication duct and the inlet of the first turbine, the valve operable to adjust an amount of exhaust gas flow to the first turbine and to the exhaust gas recirculation system.

By operating the valve to adjust the amount of flow to the first turbine, it may be possible to increase engine operating efficiency over a range of operation. For example, by closing the valve during part load conditions, throttling loses and/or back pressure may be decreased while maintaining desired pressure ratios. During full load conditions, the valve may be opened such that both turbochargers may provide sufficient flow, for example. Furthermore, back pressure may be regulated by adjusting the valve; as such, exhaust gas flow to the exhaust gas recirculation system may be adjusted.

The brief description is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The invention will be better understood from reading the following description of non-limiting embodiments, with reference to the attached drawings, wherein below:

FIG. 1 shows an example embodiment of a mobile platform supporting an engine system according to an embodiment of the invention.

FIG. 2 shows an example embodiment of a system including a two-stage turbocharger according to an embodiment of the invention.

FIG. 3 shows an example embodiment of a system including a two-stage turbocharger according to an embodiment of the invention.

FIG. 4 shows an example embodiment of a system including a two-stage turbocharger according to an embodiment of the invention.

FIG. 5 shows a flow chart illustrating a control method for a system which includes a two-stage turbocharger.

### DETAILED DESCRIPTION

The following description relates to various embodiments of a method and systems for an engine which includes a two-stage turbocharger. In one example system, the turbocharger includes a first turbocharger with a first turbine and a first compressor and a second turbocharger with a second turbine and a second compressor, where the first turbine and the second turbine are arranged in parallel and the first compressor and the second compressor are arranged in series. The system may include a duct coupling turbine inlets of the first and second turbine, and a valve coupled between the duct and the first turbine inlet. The valve may be adjusted to control exhaust gas flow to the first turbine based on engine load, for example. In another embodiment, the system may include an exhaust gas recirculation system. In such an embodiment, the valve may be adjusted to control an amount of exhaust gas recirculation based on engine operating conditions.

The inventive engine system may be employed in a variety of turbocharged, engine-driven systems. Some of these systems may be stationary, while others may be on semi-mobile or mobile platforms. Semi-mobile platforms may be relocated between operational periods, such as mounted on flatbed trailers. Mobile platforms include self-propelled vehicles. Such vehicles can include mining equipment, marine vessels, on-road transportation vehicles, off-highway vehicles (OHV), and rail vehicles. On-road transportation can include both passenger vehicles and commercial or industrial vehicles. For clarity of illustration, a locomotive is provided as an example mobile platform supporting a system incorporating an embodiment of the invention.

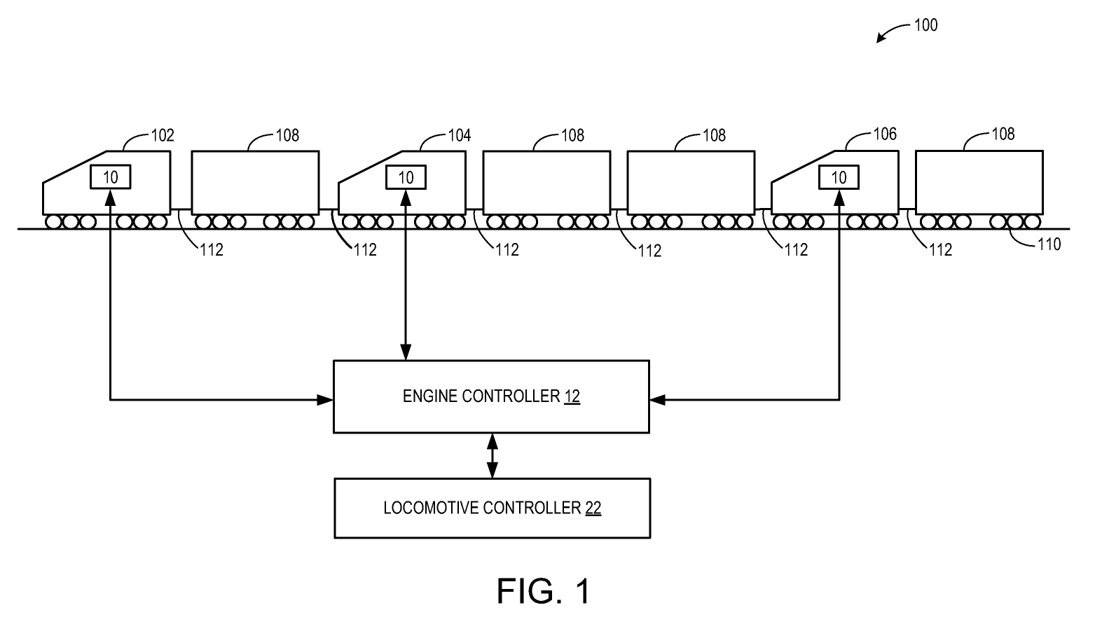

Before discussion of the inventive engine system, an example of a platform for supporting an embodiment of the engine system is disclosed. Particularly, FIG. 1 depicts an example train 100, including a plurality of locomotives 102, 104, 106 and a plurality of cars 108, configured to run on a track 110, and coupled to each other via couplers 112. The plurality of locomotives 102, 104, 106 include a lead locomotive 102 and one or more remote locomotives 104, 106. While the depicted example shows three locomotives and four cars, any appropriate number of locomotives and cars may be included in the train 100.

In one example, locomotives 102 may be diesel-electric locomotives powered by diesel engines 10. In alternate embodiments, other locomotives may be powered with an alternate engine configuration, such as a gasoline engine, a biodiesel engine, a natural gas engine, or wayside (e.g., catenary, or third-rail) electric, for example.

A locomotive controller 22 can receive information from, and transmit signals to, each of the locomotives of train 100. For example, locomotive controller 22 may receive signals from a variety of sensors on train 100, and adjust train operations accordingly. The locomotive controller 22 may be coupled to an engine controller 12 for adjusting engine operations of each locomotive. Engine controller 12 may receive one or more signals regarding operating conditions, and adjust engine operation, such as turbocharging and/or EGR operation as noted herein.

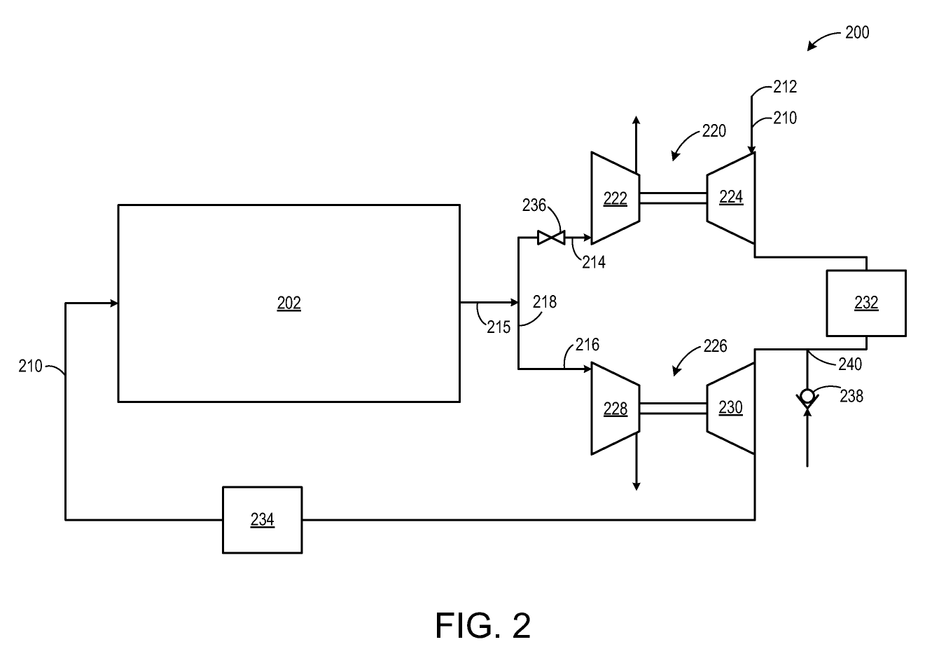

FIG. 2 depicts an example embodiment of an engine system 200 that may be included in each of the locomotives (102, 104, 106) of the train 100 (FIG. 1). In one example, the engine system 200 includes an engine 202, such as the engine 10 depicted in FIG. 1, which may be a diesel engine that combusts air and diesel fuel through compression ignition. In other non-limiting embodiments, the engine 202 may combust fuel including gasoline, natural gas, hydrogen, kerosene, biodiesel, or other petroleum distillates of similar density through compression ignition (and/or spark ignition). Further, it should be understood engine 202 is not limited to inclusion in a locomotive propulsion system; in other embodiments, engine 202 may be a stationary engine, such as in a power-plant application, or an engine in a ship or off-highway vehicle propulsion system.

The engine 202 receives intake air for combustion from an intake passage 210. The intake passage 210 receives air from a primary air inlet 212, and the air passes through an air filter (not shown) that filters the air. Exhaust gas from the cylinders flows through collecting manifolds to an exhaust passage 215 to duct 218, from where it branches into an inlet of the first turbine 214 and an inlet of the second turbine 216. The engine system 200 further includes two-stage turbocharger with first turbocharger 220 and a second turbocharger 226.

As shown in FIG. 2, the first turbocharger 220 is arranged between the intake passage 210 and the duct 218. The first turbocharger 220 includes a first turbine 222 that at least partially drives a first compressor 224 which is mechanically coupled to the first turbine 222 (e.g., via a shaft). Further, the second turbocharger 226 is arranged between the intake passage 210 and the duct 218. The second turbocharger 226 includes a second turbine 228 that at least partially drives a second compressor 230 which is mechanically coupled to the second turbine 228 (e.g., via a shaft). The turbochargers 220 and 226 increase the pressure of air drawn into the intake passage 210 in order to provide greater charge density during combustion to increase power and/or engine operating efficiency.

As depicted in FIG. 2, the first compressor 224 is positioned upstream of the second compressor 230 such that intake air that enters the intake passage 210 through the primary air inlet 212 flows through the first compressor 224 where it is compressed and then through the second compressor 230 where it is further compressed before entering the cylinders 204 of the engine 202. As such, the first compressor 224 is a low pressure compressor which is part of a low pressure turbocharger, and the second compressor 230 is a high pressure compressor which is part of a high pressure turbocharger. Furthermore, substantially all of the air that flows through the first compressor 224 flows through the second compressor 230 such that the first and second compressors are arranged in series. In contrast, as depicted, the first turbine 222 and the second turbine 228 are arranged in parallel. For example, exhaust gas that flows out of the first engine bank 206 or the second engine bank 208 and through the first turbine 222 does not flow through the second turbine 228, and exhaust gas that flows out of the first engine bank 206 or second engine bank 208 and through the second turbine 228 does not flow through the first turbine 222.

In some embodiments, the first turbine 222 and the second turbine 228 may be substantially the same. In other embodiments, the first turbine 222 and the second turbine 228 may be different. The first compressor 224 and the second compressor 230 may be different because of the different pressures. As an example, the second turbine 228 may be designed to spin faster than the first turbine 222, as a higher pressure prevails in the second compressor 230, which is therefore smaller and spins faster than the first compressor 224. The first and second turbocharger may be designed to provide desired pressure ratios for a particular engine system, for example.

In the example embodiment of FIG. 2, the engine system 200 further includes an intercooler 232 positioned downstream of the first compressor 224 and upstream of the second compressor 230 which cools the intake air compressed by the first compressor 224 before it enters the second compressor 230. The engine system 200 further includes an aftercooler 234 positioned downstream of the second compressor 230 which cools the intake air compressed by the second compressor 230 before the intake air enters the cylinders 204 of the engine 202.

As depicted in FIG. 2, the engine system 200 includes a valve 236 positioned between the duct 218 and inlet of the first turbine 214. before. The valve 236 may be adjusted (e.g., via a controller such as engine controller 12 depicted in FIG. 1) to control an amount of exhaust gas that enters the first turbine 222. In this manner, exhaust flow to the first turbocharger 220 may be substantially reduced or cut off so that only the second turbocharger 226 provides compressed air to the engine (e.g., during part load operation). When exhaust flow to the first turbine 222 is cut off, substantially all the exhaust flow may flow through the second turbine 228. In some embodiments, the valve 236 may be a gate valve that may be moved between an open position such that exhaust gas flows to the first turbine 222 or a closed position such that substantially no exhaust gas flows to the first turbine 222. In other embodiments, the valve 236 may be a proportional control valve such as a butterfly valve which may be adjusted to control an amount of flow that enters the first turbine 222. It should be understood, the valve 236 may be any suitable valve for a particular engine system configuration.

In the example embodiment depicted in FIG. 2, the engine system further includes a valve 238, such as a check valve, positioned along the intake passage 210 at a second air inlet 240. In other embodiments, the engine system may not include a check valve positioned at a second air inlet. The second air inlet 240, and thus the check valve 238, are positioned downstream of the intercooler 232 and upstream of the second compressor 230. A change in pressure in the intake passage 210 may cause the check valve 238 to open so that the second compressor 230 receives intake air when the first turbocharger 220 is not providing compressed air to the second compressor 230 (e.g., when the valve 236 is closed), for example. Likewise, a pressure in the intake passage 210 may cause the check valve 238 to close such that air does not enter the intake passage through the second air inlet 240 when the first turbocharger 220 is providing compressed air to the second compressor 230 (e.g., when the valve 236 is open).

Thus, the engine system includes a two-stage turbocharger which includes a first compressor and a second compressor in series and a first turbine and a second turbine in parallel. In such a configuration, exhaust flow to the first turbine may be reduced by adjusting the valve in the first turbine inlet such that the engine system operates with the second turbocharger and not the first turbocharger.

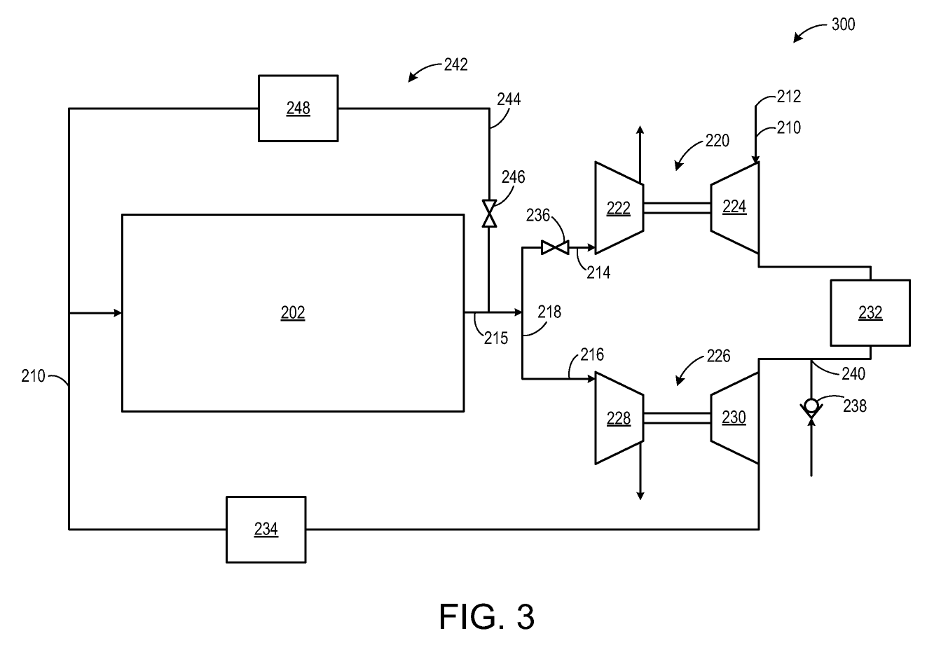

FIG. 3 shows another example embodiment of an engine system 300 that may be included in each of the locomotives (102, 104, 106) of the train 100 (FIG. 1). The embodiment illustrated in FIG. 3 is comprised of many of the same components as the embodiments illustrated in FIG. 2. Accordingly, those components which function similarly to those illustrated in FIG. 2 are identified by like reference numerals in FIG. 3 and may not be described again.

The engine system 300 includes an exhaust gas recirculation (EGR) system 242 which routes exhaust gas from the exhaust passage 215 upstream of the duct 218 and the inlets of the first and second turbines 214 and 216 to the intake passage 210 downstream of the aftercooler 234. The EGR system 242 includes an EGR passage 244 and an EGR valve 246 for controlling an amount of exhaust gas that is recirculated from the first engine bank 206 and the second engine bank 208 of the engine 202 to the intake passage 210 of the engine 202. By introducing exhaust gas to the cylinders 204 of the engine 202, the amount of available oxygen for combustion is decreased, thereby reducing the combustion flame temperatures and reducing the formation of nitrogen oxides (e.g., NOₓ). The EGR valve 246 may be an on/off valve controlled by the controller, such as the engine controller 12 described above with reference to FIG. 1, or it may control a variable amount of EGR, for example.

In some embodiments, as shown in FIG. 3, the EGR system 242 further includes an EGR cooler 248 to reduce the temperature of the exhaust gas before it enters the intake passage 210. As shown in the non-limiting example embodiment of FIG. 3, the EGR system 242 is a high-pressure EGR system. In other embodiments, the engine system 300 may additionally or alternatively include a low-pressure EGR system, routing EGR from downstream of the first turbine 222 and/or the second turbine 228 to upstream of the first compressor 224 and/or the second compressor 230, respectively.

In an embodiment in which the engine system includes an EGR system, such as depicted in FIG. 3, an amount of EGR may be further regulated by adjusting the valve 236 which controls the exhaust gas flow to the first turbine 222, as will be described in greater detail below. For example, when the valve 236 is closed, the pressure in the exhaust passage 215 may increase thereby increasing the EGR flow when the EGR valve 246 is open.

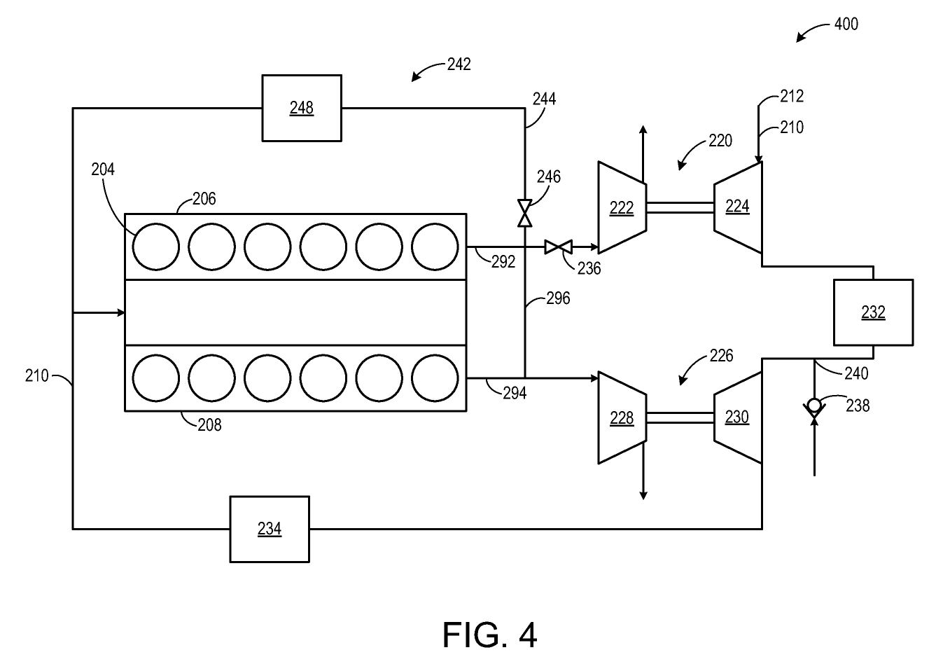

FIG. 4 shows another example embodiment of an engine system 400. The embodiment illustrated in FIG. 4 is comprised of many of the same components as the embodiments illustrated in FIGS. 2 and 3. Accordingly, those components which function similarly to those illustrated in FIGS. 2 and 3 are identified by like reference numerals in FIG. 4 and may not be described again.

As depicted in FIG. 4, the engine system 400 includes an engine 202, which is a 12-cylinder engine that includes twelve cylinders 204 arranged in two engine banks 206, and 208, such as in a V-12 configuration. In other embodiments, the engine may be a V-6, V-16, I-4, I-6, I-8, opposed 4, or another engine type.

Further, in engine system 400, exhaust gas resulting from combustion in the first engine bank 206 is supplied to a first exhaust passage 292 and exhaust gas resulting from combustion in the second engine bank is supplied to a second exhaust passage 294. As shown, a communication duct 296 fluidically couples the first exhaust passage 292 and the second exhaust passage 294 such that exhaust gas from the first engine bank 206 can flow into the second exhaust passage 294 and exhaust gas from the second engine bank 208 can flow into the first exhaust passage 292.

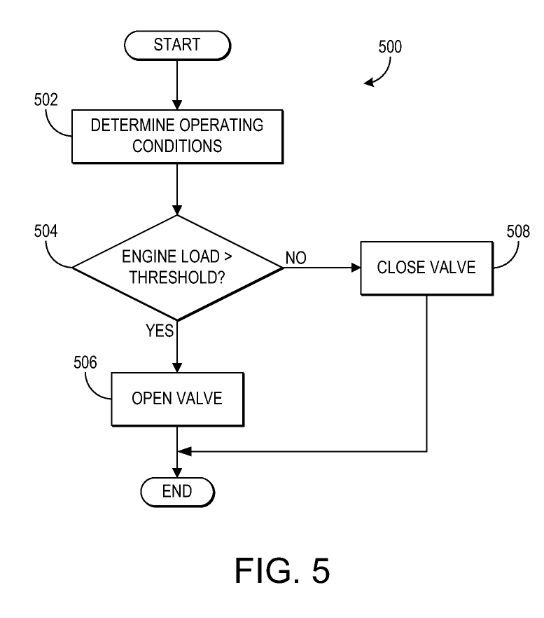

Continuing to FIG. 5, a flow chart is shown which illustrates a method 500 for a system which includes a two-stage turbocharger, such as engine system 200 described above with reference to FIG. 2. Specifically, method 500 adjusts the position of the valve positioned at the inlet of the first turbine based on engine load.

At 502 of method 500, engine operating conditions are determined. Engine operating conditions may include engine speed, engine torque, amount of boost, engine oil temperature, compressor air pressure, or the like.

Once the engine operating conditions are determined, method 500 proceeds to 504 where it is determined if the engine load is greater than an engine load threshold value. In one example, the engine load threshold value may be based on an amount of boost desired during current operating conditions. As another example, the engine load threshold value may be based on throttling losses associated with the current operating conditions. For example, the engine load threshold value may be part load, full load, or idle engine operation.

If it is determined that the engine load is greater than the engine load threshold value, the method continues to 506 and the valve is opened. As an example, if the load threshold value is only a part load, and the engine is operating under full load, the valve may be opened such that the valve does not obstruct exhaust gas flow to the first turbine. As such, the engine may operate with both turbochargers, and therefore, with increased pressure ratios, for example.

On the other hand, if it is determined that the engine load is less than the engine load threshold value, the method moves to 508 where the valve is closed such that little or no exhaust gas enters the first turbine. In this way, the engine receives compressed air from the second turbocharger and not the first turbocharger. As described above, the engine system may include a check valve which opens due to a pressure in the intake passage when the first turbocharger is not spinning. As such, the second compressor receives air from the second air inlet, which does not pass through the first compressor, instead of the primary air inlet. In one example, the valve may be closed when the engine is operating at part load. By closing the valve during part load operation, the engine system may operate with decreased throttling loses and/or decreased back pressure while maintaining desired pressure ratios, thereby improving engine performance and increasing turbocharger efficiency, for example. Further, during full load operation and/or medium load operation, the valve may be open and thus it is possible to achieve improved turbocharger efficiency during these conditions.

In some embodiments in which the valve is a proportional control valve, for example, the valve position maybe adjusted so that an amount of exhaust gas that passes through the first turbine inlet may be reduced. In such an example, the first compressor may continue to supply the second turbocharger with compressed air.

Thus, the valve may be controlled such that the engine system operates with one or two turbochargers. During part load conditions, the valve may be closed to improve the pressure ratio on the second turbine. During full load conditions, the valve may be opened such that both turbochargers may provide sufficient flow, for example. Further, the valve positioned at the inlet of the first turbine of the first turbocharger may be adjusted to vary an amount of exhaust gas recirculation delivered to the engine in response to engine operating conditions.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A system for an engine, comprising:
a two-stage turbocharger, where a first turbocharger has a first turbine and a first compressor and a second turbocharger has a second turbine and a second compressor, and where the first turbine and the second turbine are arranged in parallel and the first compressor and the second compressor are arranged in series;
a duct coupling turbine inlets of the first and second turbine; and
a valve coupled between the duct and the first turbine inlet.

2. The system of claim 1, wherein the valve is coupled downstream of the duct in the turbine inlet of the first turbine.

3. The system of claim 2, wherein the valve is a proportional control valve.

4. The system of claim 1, wherein the first compressor is positioned in an intake passage of the engine downstream of a primary ambient air inlet and upstream of the second compressor.

5. The system of claim 4, further comprising a check valve positioned at a second ambient air inlet which is located along the intake passage of the engine downstream of the first compressor and upstream of the second compressor.

6. The system of claim 5, further comprising an intercooler positioned in the intake passage downstream of the first compressor and upstream of the second ambient air inlet.

7. The system of claim 1, further comprising an aftercooler positioned downstream of the second compressor.

8. The system of claim 1, further comprising an exhaust gas recirculation system with an exhaust gas inlet located upstream of the inlets of first and second turbines

9. A method for an engine having an exhaust gas recirculation system and a two-stage turbocharger, the two-stage turbocharger including a first turbocharger and a second turbocharger, comprising:
based on an engine load, adjusting exhaust gas flow to a turbine of the first turbocharger, where the turbine of the first turbocharger is arranged in parallel with a turbine of the second turbocharger, and a compressor of the first turbocharger is arranged in series with a compressor of the second turbocharger; and
adjusting an amount of exhaust gas recirculation drawn from upstream of both of the first and second turbines.

10. The method of claim 9, wherein adjusting exhaust gas flow to the turbine of the first turbocharger includes adjusting a valve positioned upstream of an inlet of the turbine of the first turbocharger.

11. The method of claim 10, wherein adjusting the amount of exhaust gas recirculation includes adjusting the valve positioned upstream of the inlet of the turbine of the first turbocharger.

12. The method of claim 11, wherein adjusting the amount of exhaust gas recirculation by adjusting the valve positioned upstream of the inlet of the turbine of the first turbocharger is based on engine operating conditions.

13. The method of claim 10, wherein the valve is adjusted to be open when the engine load is greater than a threshold value.

14. The method of claim 13, further comprising receiving ambient air from a primary air inlet upstream of the compressor of the first turbocharger when the valve is open.

15. The method of claim 10, wherein the valve is adjusted to be closed when the engine load is less than a threshold value.

16. The method of claim 15, further comprising receiving air from a second inlet downstream of the compressor of the first turbocharger and upstream of the compressor of the second turbocharger when the valve is closed.

17. The method of claim 10, the valve is a proportional control valve, and wherein adjusting the amount of exhaust gas recirculation includes adjusting a position of the valve to increase or decrease exhaust flow through the valve.

18. A system for an engine, comprising:
a first turbocharger including both a first turbine with a first turbine inlet positioned in a first exhaust passage through which exhaust gas flows, and a first compressor positioned downstream of a primary air inlet of an intake passage and through which intake air flows;
a second turbocharger including both a second turbine with a second turbine inlet positioned in a second exhaust passage through which exhaust gas flows, and a second compressor positioned downstream of the first compressor in the intake passage;
a structure defining a communication duct coupling the first exhaust passage to the second exhaust passage upstream of the first turbine inlet and the second turbine inlet;
an exhaust gas recirculation system having an exhaust gas inlet upstream of the first turbine inlet and the second turbine inlet; and
a valve positioned between the communication duct and the inlet of the first turbine, the valve operable to adjust an amount of exhaust gas flow to the first turbine and to the exhaust gas recirculation system.

19. The system of claim 18, further comprising a controller communicating with the valve and operable to control the valve to open or close based on an engine load.

20. The system of claim 18, further comprising a check valve positioned at a second air inlet, the second air inlet located downstream of the first compressor and upstream of the second compressor.
